(19) United States
(12) Patent Application Publication
(10) Pub. No.: US 2013/0156581 A1
(43) Pub. Date: Jun. 20, 2013

(54) APPARATUS FOR GENERATING ELECTRIC POWER FROM WIND ENERGY

(71) Applicant: Chun-Neng CHUNG, Pingtung County (TW)

(72) Inventor: Chun-Neng CHUNG, Pingtung County (TW)

(73) Assignee: FUNG GIN DA ENERGY SCIENCE AND TECHNOLOGY CO., LTD, Pingtung County (TW)

(21) Appl. No.: 13/525,026

(22) Filed: Jun. 15, 2012

(30) Foreign Application Priority Data
Dec. 16, 2011 (TW) 100146849

(51) Int. Cl. F03D 3/06; F03D 11/00; F03D 7/06

(52) U.S. Cl. 416/155

(57) ABSTRACT

An apparatus for generating electric power from wind energy includes a blade unit, a wind-collecting unit, and a control unit. The blade unit includes an upright shaft mounted rotatably on a base, and a plurality of blades connected fixedly around the shaft and driven by wind to rotate. A generator is connected to the shaft for converting rotational kinetic energy into electric power. The wind-collecting unit includes upright plates mounted pivotally on the base and disposed around the blades. The control unit detects rotational speed of the shaft and accordingly moves at least a portion of each upright plate between first and second positions, where the amount of wind flowing toward the blades is increased and reduced, respectively.

### CROSS-REFERENCE TO RELATED APPLICATION

This application claims priority of Taiwanese Patent Application No. 100146849, filed on Dec. 16, 2011.

### BACKGROUND OF THE INVENTION

1. Field of the Invention

The invention relates to an energy converting apparatus, more particularly to an apparatus capable of converting wind energy into electric power.

2. Description of the Related Art

Due to the rise in environmental consciousness, economizing on power consumption has become an important issue. Referring to FIG. 1, a conventional apparatus 1 for generating electric power from wind energy is shown to include an upright prop 11, a windmill 12, and a generator 13. The windmill 12 is mounted at one end of the upright prop 11, and includes a plurality of blades 121 driven by wind to rotate. The windmill 12 converts the wind energy into rotational kinetic energy. The generator 13 is coupled to the windmill 12 to convert the rotational kinetic energy into electric power.

However, such an apparatus 1 has a huge volume that occupies a relatively wide area. It is typically built in a place remote from a city, and thus, energy loss during transmission and building cost of the conventional apparatus 1 are increased. Further, since wind power is unstable, it is difficult to drive the blades 121 to rotate stably such that generating efficiency of the conventional apparatus is unstable.

Referring to FIG. 2, Taiwanese Patent Publication No. M338278 discloses another conventional apparatus 2 for generating electric power from wind energy. The apparatus 2 comprises a wind-collecting unit 21, a blade unit 22, and a generator 23. The blade unit 22 includes an upright shaft 221 mounted on a base, and a plurality of blades 222 connected fixedly to and co-rotatable with the upright shaft 221.

The wind-collecting unit 21 includes a plurality of upright plates 211 that are fixed on the base and that are angularly equidistant and disposed around the blade unit 22. Any adjacent two of the upright plates 211 define an inwardly converging wind-guiding channel therebetween. The upright plates 211 are shaped so that wind is collected from different directions to flow directly toward the blades 222 of the blade unit 22 via the wind-guiding channels so as to rotate the blades 222 together with the upright shaft 221 to generate rotational kinetic energy. The generator 23 is coupled to the upright shaft 221 to convert the rotational kinetic energy into electric power.

Although the above-mentioned apparatus 2 can provide an effective way of generating electric power from wind energy, the blade unit 22 and the generator 23 may be damaged when tornado or typhoon occurs, since the wind-collecting unit 21 collects wind to flow toward the blade unit 22. Consequently, the service life of the conventional apparatus 2 is relatively short.

### SUMMARY OF THE INVENTION

Therefore, the object of the present invention is to provide an apparatus capable of controlling an amount of wind flowing toward a blade unit.

According to the present invention, there is provided an apparatus for generating electric power from wind energy. The apparatus comprises a base, a blade unit, a generator, a wind-collecting unit, and a control unit. The blade unit includes an upright shaft that extends axially along a pivot axis and that is mounted rotatably on the base, and at least one blade member that has a plurality of blades connected fixedly around the upright shaft and driven by wind to rotate about the pivot axis for converting wind energy into rotational kinetic energy. The generator is connected to the upright shaft of the blade unit for converting the rotational kinetic energy into electric power. The wind-collecting unit includes a plurality of wind-collecting plates that are mounted pivotally on the base and that are disposed around the blades of the blade member with angular equidistance. The control unit includes a detector for detecting rotational speed of the upright shaft of the blade unit and for generating a control signal according to the rotational speed, and at least one driver coupled to the detector for receiving the control signal therefrom and responsive to the control signal for moving at least a portion of each of the wind-collecting plates between a first position, where any adjacent two of the wind-collecting plates define a wind guiding channel therebetween that has a wind inlet and a wind outlet facing the upright shaft, and that converges from the wind inlet toward the wind outlet so as to collect the wind to flow directly toward the blades, and a second position, where the wind outlet has a dimension not smaller than a dimension of the wind inlet so as to reduce the amount of the wind flowing toward the blades.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional apparatus for generating electric power from wind energy;

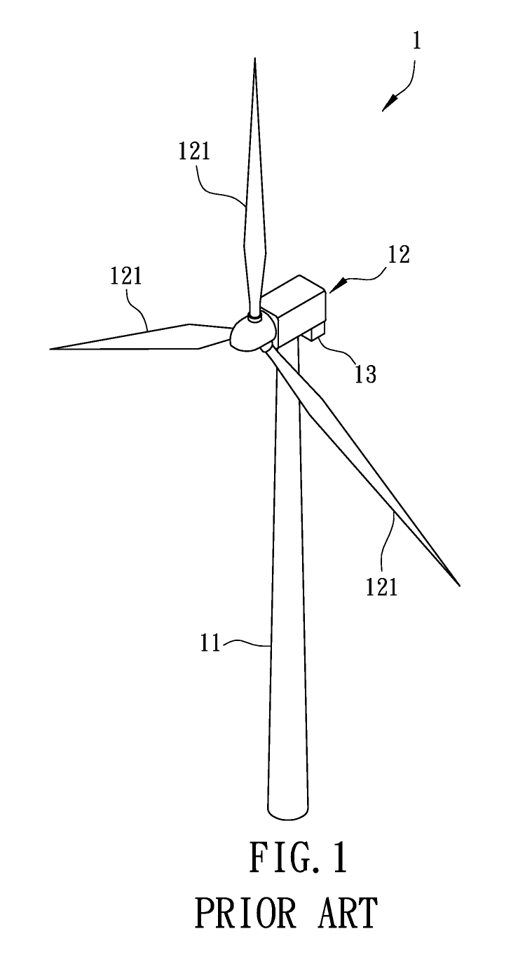

FIG. 2 is an exploded perspective view of another conventional apparatus for generating electric power from wind energy disclosed in Taiwanese Patent Publication No. M338278;

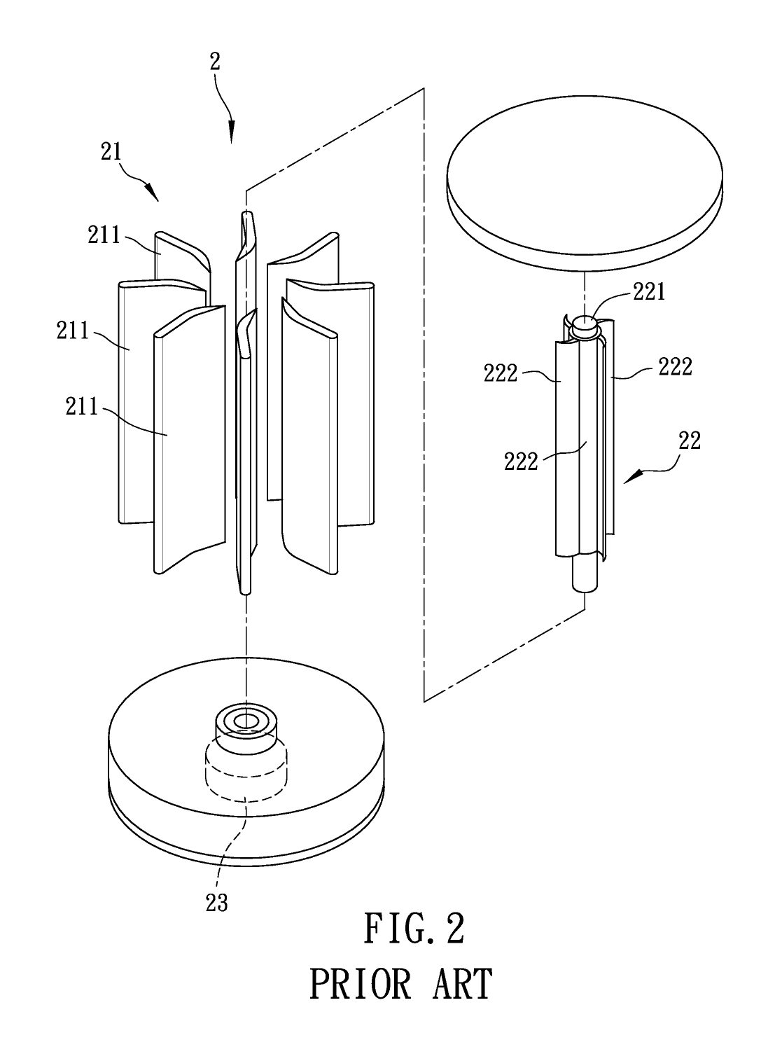

FIG. 3 is an exploded perspective view of a first preferred embodiment of an apparatus for generating electric power from wind energy according to the present invention;

FIG. 4 is a schematic sectional view of the first preferred embodiment;

FIG. 5 is a schematic top view of the first preferred embodiment for illustrating a wind-collecting unit of the apparatus at a first position, where wind is collected to flow directly toward a blade unit of the apparatus;

FIG. 6 is a schematic top view of the first preferred embodiment for illustrating the wind-collecting unit at a second position, where the amount of wind flowing toward the blade unit is reduced;

FIG. 7 is a schematic top view of the first preferred embodiment for illustrating the wind-collecting unit arranged circumferentially around the blade unit so as to prohibit wind from flowing toward the blade unit;

FIG. 8 is a partly exploded perspective view of a second preferred embodiment of an apparatus according to the present invention;

FIG. 9 is a partly exploded perspective view of a third preferred embodiment of an apparatus according to the present invention;

FIG. 10 is a schematic top view of the third preferred embodiment for illustrating second guiding segments of the wind-collecting unit at the first position;

FIG. 11 is a schematic top view illustrating the second guiding segments at the second position;

FIG. 12 is a schematic top view of the third preferred embodiment for illustrating the second guiding segments arranged circumferentially around the blade unit; and

FIG. 13 is a partly exploded perspective view of a fourth preferred embodiment of an apparatus according to the present invention.

### DETAILED DESCRIPTION OF THE PREFERRED EMBODIMENTS

Before the present invention is described in greater detail, it should be noted that like elements are denoted by the same reference numerals throughout the disclosure.

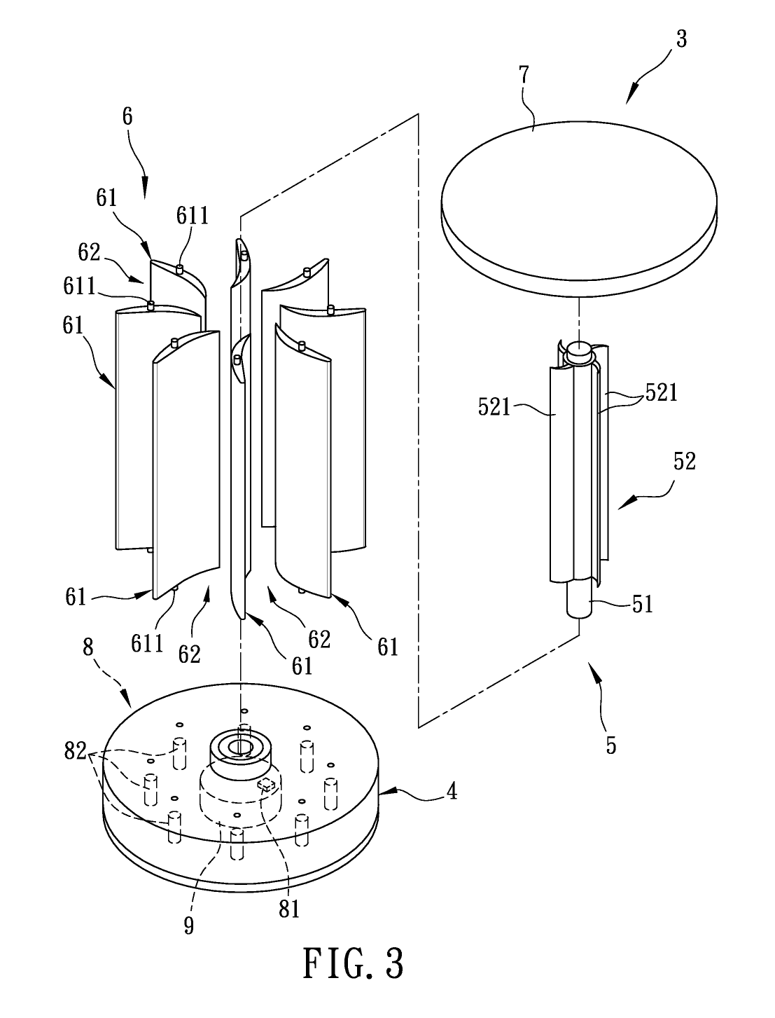

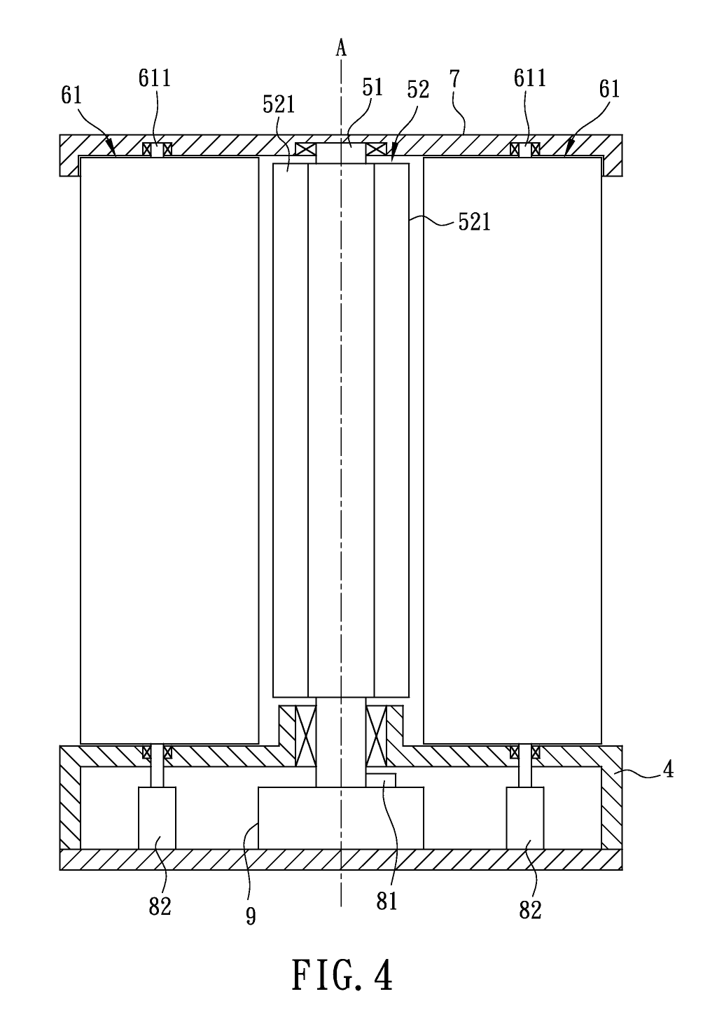

A first preferred embodiment of an apparatus 3 for generating electric power from wind energy according to the present invention is shown in FIGS. 3 and 4. The apparatus 3 comprises a hollow base 4, a blade unit 5, a generator 9, a wind-collecting unit 6, a top wall 7, and a control unit 8.

The blade unit 5 includes an upright shaft 51 that extends axially along a pivot axis (A) and that is mounted rotatably on the base 4, and a blade member 52 that includes a plurality of blades 521 connected fixedly around the upright shaft 51 and driven by wind to rotate about the pivot axis (A) for converting wind energy into rotational kinetic energy.

The generator 9 is connected to the upright shaft 51 of the blade unit 5 for converting the rotational kinetic energy into electric power.

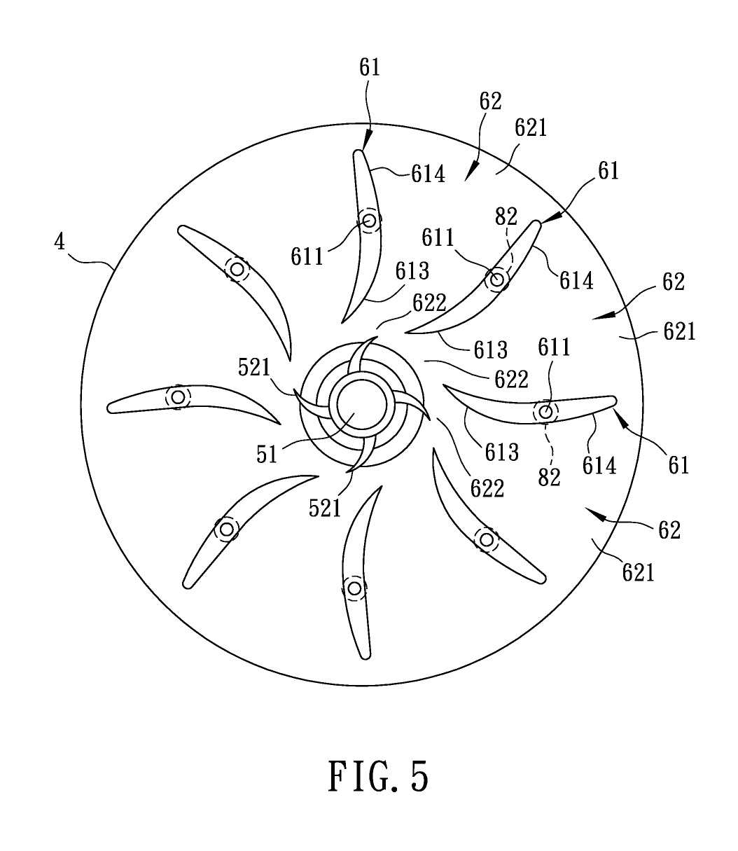

The wind-collecting unit 6 includes a plurality of wind-collecting plates 61 disposed around the blades 521 of the blade member 52 with angular equidistance. Further referring to FIG. 5, each of the wind-collecting plates 61 includes a first guiding segment 613, a second guiding segment 614 connected to the first guiding segment 613, and a driving shaft 611 extending in an axial direction parallel to the pivot axis (A) and mounting a corresponding one of the wind-collecting plates 61 pivotally to the base 4.

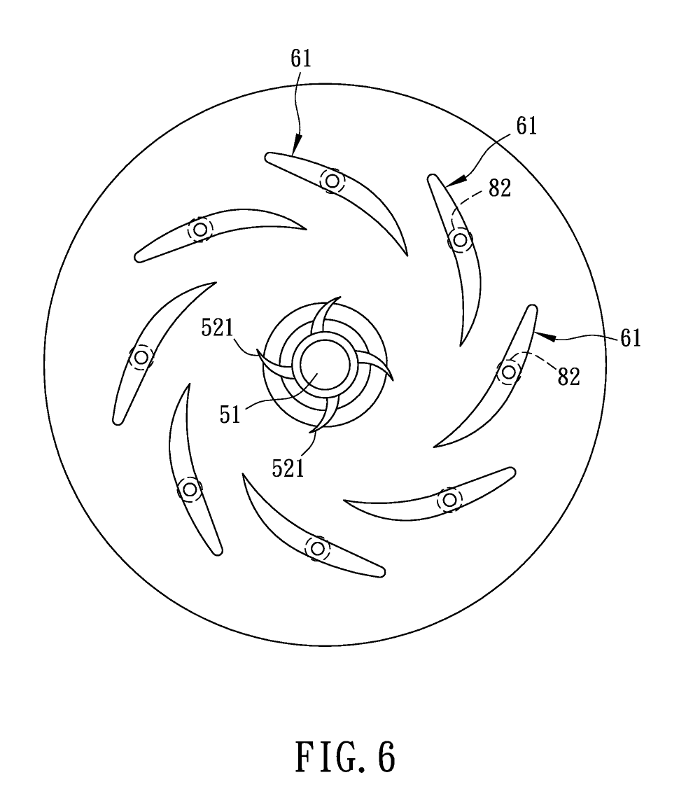

The control unit 8 includes a detector 81 and a plurality of drivers 82. The detector 81 is for detecting rotational speed of the upright shaft 51 of the blade unit 5 and for generating a control signal according to the rotational speed. Each of the drivers 82 is coupled to the detector 81 for receiving the control signal therefrom and is responsive to the control signal for driving the driving shaft 611 of a respective one of the wind-collecting plates 61 to rotate and for moving the respective one of the wind-collecting plates 61 between a first position (see FIG. 5) and a second position (see FIG. 6). At the first position, any adjacent two of the wind-collecting plates 61 define a wind guiding channel 62 therebetween having a wind inlet 621 that is defined by the second guiding segments 614 of the corresponding two wind-collecting plates 61 and a wind outlet 622 that is defined by the first guiding segments 613 of the corresponding two wind-collecting plates 61 and that faces the upright shaft 51. In particular, each of the wind guiding channels 62 converges from the wind inlet 621 thereof toward the wind outlet 622 thereof so as to collect the wind to flow directly toward the blades 521 of the blade unit 5. At the second position, each of the wind outlets 622 has a dimension (i.e., a distance between corresponding two first guiding segments 613) not smaller than a dimension (i.e., a distance between corresponding two second guiding segments 614) of a corresponding wind inlet 621 so as to reduce the amount of the wind flowing toward the blades 521.

It is noted that, in this embodiment, the first and second guiding segments 613, 614 of each wind-collecting plate 61 are formed integrally with each other, and each of the wind-collecting plates 61 is tapered from the second guiding segment 614 thereof toward the first guiding segment 613 thereof.

The top wall 7 is disposed over the upright shaft 51 and the driving shafts 611, and covers the blade unit 5 and the wind-collecting unit 6. The upright shaft 51 and the driving shafts 611 are rotatably mounted between the top wall 7 and the base 2.

As shown in FIG. 5, when the wind-collecting plates 61 move to the first position, the first guiding segments 613 are disposed adjacent to and point toward the upright shaft 51, and the second guiding segments 614 extend radially and outwardly.

By this way, wind from different directions can be collected by the wind-collecting plates 61 to flow directly toward the blades 521 of the blade unit 5 from the wind inlets 622 toward the wind outlets 622 through the wind-guiding channels 62. Consequently, the blades 521 are effectively driven by the wind to rotate about the pivot axis (A) together with the upright shaft 51 so as to convert wind energy into rotational kinetic energy. Thereafter, the generator 9 converts the rotational kinetic energy into electric power.

Referring to FIG. 6, when it is detected by the detector 81 of the control unit 8 (shown in FIGS. 3 and 4) that the rotational speed of the upright shaft 51 exceeds a predetermined threshold, the detector 81 generates the control signal to be received by the drivers 82. In response to receipt of the control signal from the detector 81, the drivers 82 move the wind-collecting plates 61 from the first position (see FIG. 5) to the second position (see FIG. 6). Accordingly, the amount of the wind flowing toward the blades 521 of the blade unit 5 can be reduced, and thus, the rotational speed of the upright shaft 51 is slowed down.

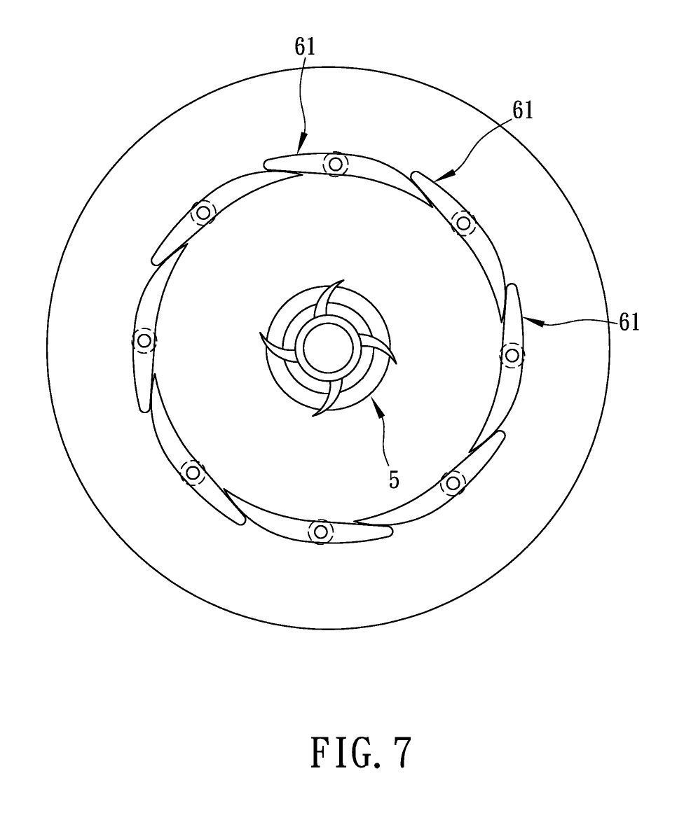

Additionally, referring to FIG. 7, the wind-collecting plates 61 can be arranged circumferentially around the blade unit 5 when tornado or typhoon occurs so as to prohibit wind from flowing toward the blade unit 5. Thus, the blade unit 5 and the generator 9 are protected from damage, and the service life of the apparatus 3 can be prolonged.

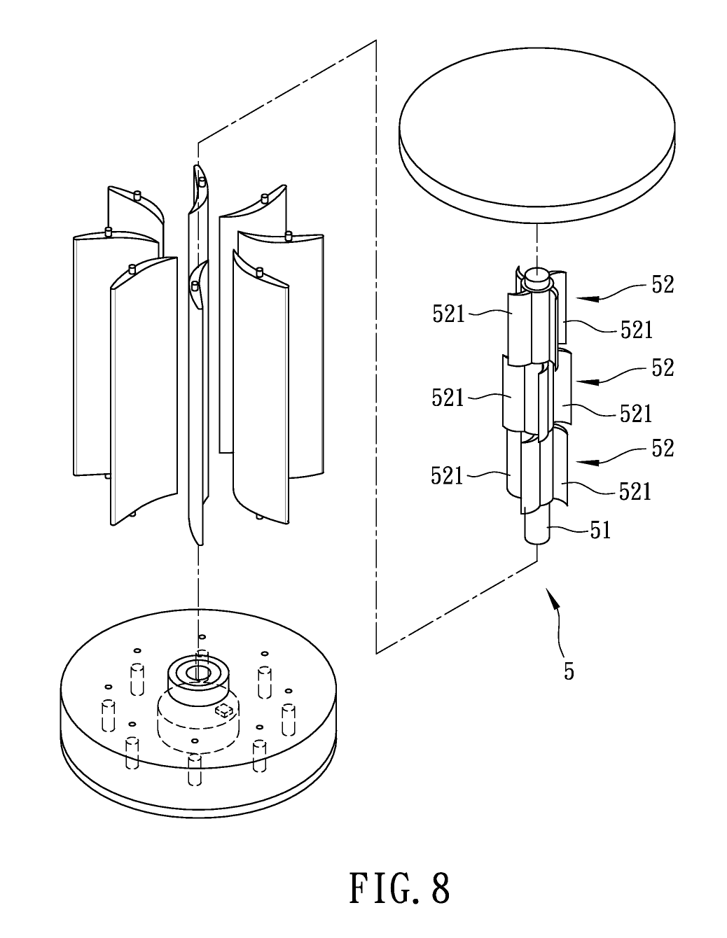

As shown in FIG. 8, a second preferred embodiment of the apparatus 3 according to the present invention has a structure similar to that of the first embodiment. The main difference between the second embodiment and the first embodiment resides in that the blade unit 5 includes a plurality of the blade members 52 arranged axially along the upright shaft 51 in the second embodiment. The blades 521 of each of the blade members 52 are misaligned respectively from those of an adjacent one of the blade members 52 along the pivot axis (A).

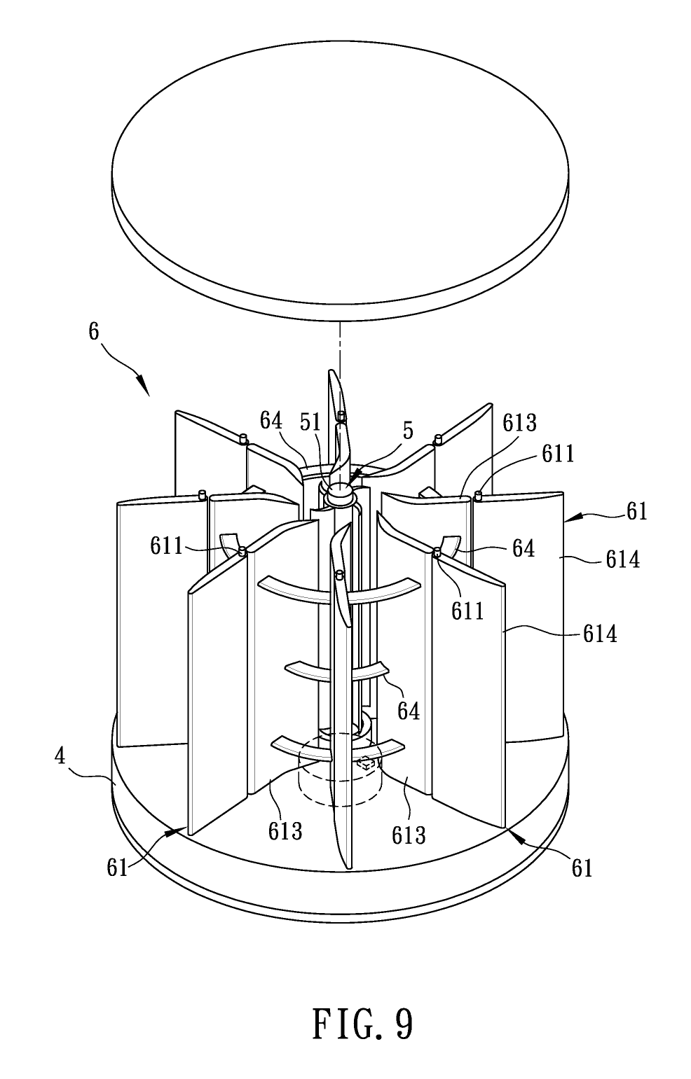

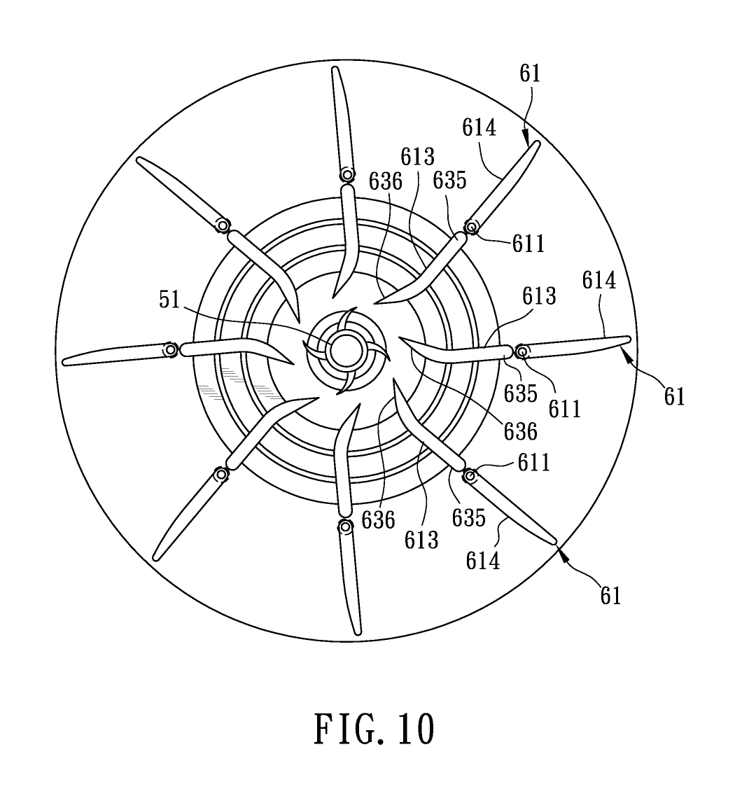

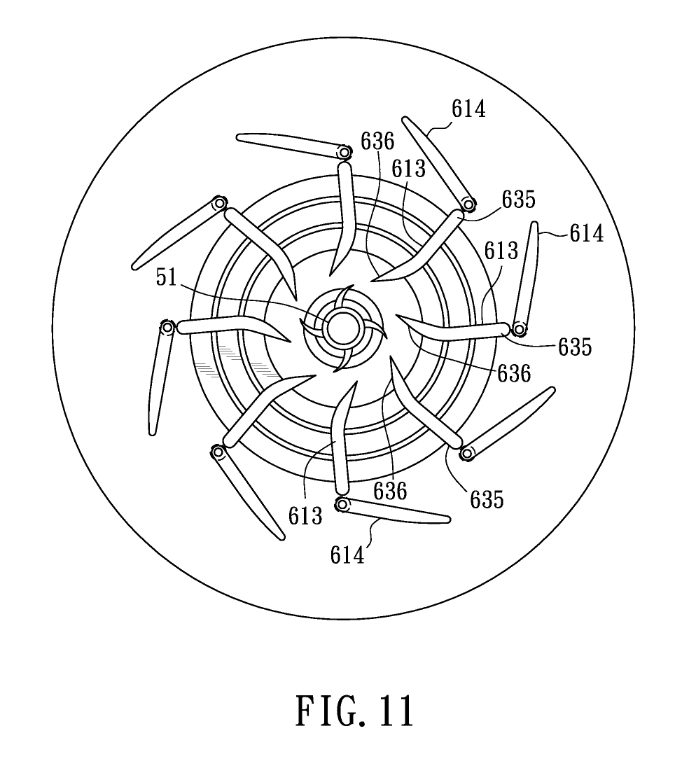

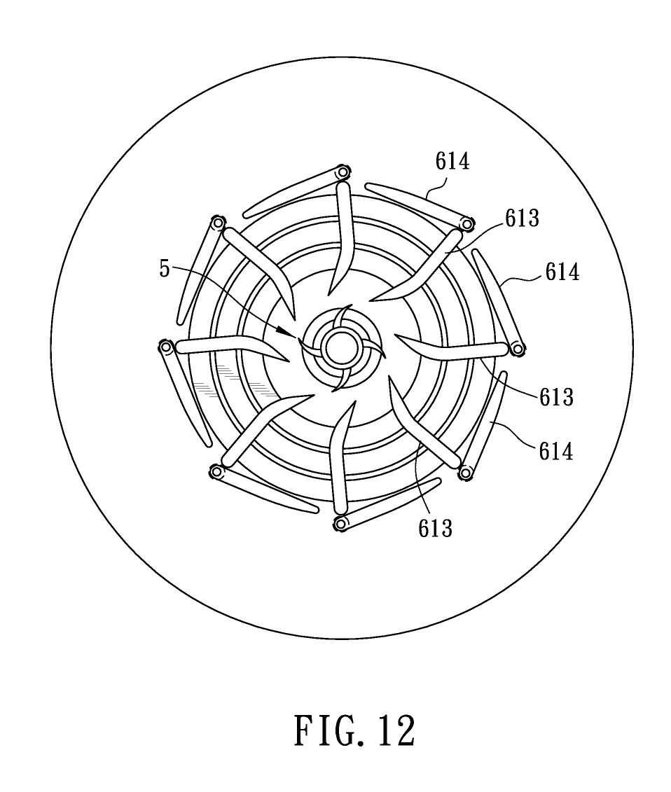

Referring to FIGS. 9 to 12, a third preferred embodiment of the present invention is shown. In this embodiment, the first guiding segment 613 of each wind-collecting plate 61 is fixedly disposed adjacent to and points toward the upright shaft 51 of the blade unit 5, and the second guiding segment 614 of each wind-collecting plate 61 is mounted pivotally to the base 4 through the driving shaft 611 of the corresponding wind-collecting plate 61 and is rotated by the driving shaft 611 to move between the first position (see FIG. 10) and the second position (see FIG. 11). Each first guiding segment 613 has a first end 636 pointing toward the upright shaft 51 and a second end 635 opposite to the first end 636 and adjacent to the corresponding second guiding segment 614. The wind-collecting unit 6 further includes a plurality of reinforcing members 64 each interconnecting the first guiding segments 613 of adjacent two of the wind-collecting plates 61, thus enhancing structural strength of the first guiding segments 613 of the wind-collecting plates 61. Additionally, referring to FIG. 12, the second guiding segments 614 can be arranged to circumferentially surround the first guiding segments 613 and the blade unit 5 when tornado or typhoon occurs.

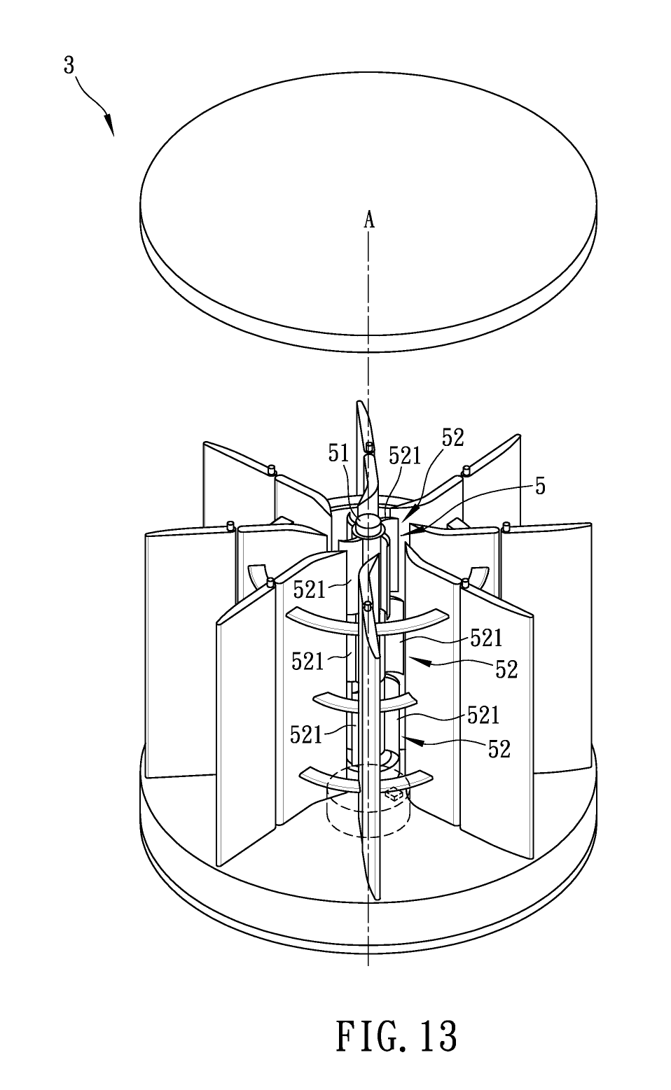

As shown in FIG. 13, a fourth preferred embodiment of the apparatus 3 according to the present invention has a structure similar to that of the third embodiment. The main difference between the fourth embodiment and the third embodiment resides in that the blade unit 5 includes a plurality of the blade members 52 arranged axially along the upright shaft 51 in this embodiment. The blades 521 of each of the blade members 52 are misaligned respectively from those of an adjacent one of the blade members 52 along the pivot axis (A).

To sum up, due to the presence of the control unit 8, at least a portion of each wind-collecting plate 61 can be moved between the first and second positions by the drivers 82 as required according to the rotational speed of the upright shaft 51 detected by the detector 81. Consequently, the apparatus 3 of the present invention is capable of preventing damage of the blade unit 5 and the generator 9 as well as providing an effective way of generating electric power from wind energy.

While the invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An apparatus for generating electric power from wind energy, comprising:
a base;
a blade unit including an upright shaft that extends axially along a pivot axis and that is mounted rotatably on said base, and at least one blade member that has a plurality of blades connected fixedly around said upright shaft and driven by wind to rotate about the pivot axis for converting wind energy into rotational kinetic energy;
a generator connected to said upright shaft of said blade unit for converting the rotational kinetic energy into electric power;
a wind-collecting unit including a plurality of wind-collecting plates that are mounted pivotally on said base and that are disposed around said blades of said blade member with angular equidistance; and
a control unit including a detector for detecting rotational speed of said upright shaft of said blade unit and for generating a control signal according to the rotational speed, and at least one driver coupled to said detector for receiving the control signal therefrom and responsive to the control signal for moving at least a portion of each of said wind-collecting plates between a first position, where any adjacent two of said wind-collecting plates define a wind guiding channel therebetween that has a wind inlet and a wind outlet facing said upright shaft, and that converges from said wind inlet toward said wind outlet so as to collect the wind to flow directly toward said blades, and a second position, where said wind outlet has a dimension not smaller than a dimension of said wind inlet so as to reduce an amount of the wind flowing toward said blades.

2. The apparatus as claimed in claim 1, wherein each of said wind-collecting plates includes a first guiding segment, a second guiding segment connected to said first guiding segment, and a driving shaft extending in an axial direction parallel to the pivot axis, mounting a corresponding one of said wind-collecting plates pivotally to said base, and being rotated by said driver to move the corresponding one of said wind-collecting plates between the first and second positions, each of said wind-collecting plates being tapered from said second guiding segment thereof toward said first guiding segment thereof, said first guiding segments being disposed adjacent to and pointing toward said upright shaft and said second guiding segments extending radially and outwardly when said wind-collecting plates move to the first position.

3. The apparatus as claimed in claim 2, wherein said blade unit includes a plurality of said blade members arranged axially along said upright shaft, said blades of each of said blade members being misaligned respectively from those of an adjacent one of said blade members along the pivot axis.

4. The apparatus as claimed in claim 3, further comprising a top wall disposed over said upright shaft and said driving shafts and covering said blade unit and said wind-collecting unit, said upright shaft and said driving shafts being rotatably mounted between said top wall and said base.

5. The apparatus as claimed in claim 2, wherein said first guiding segments of adjacent two of said wind-collecting plates define said wind outlet therebetween, and said second guiding segments of adjacent two of said wind-collecting plates define said wind inlet therebetween.

6. The apparatus as claimed in claim 1, wherein each of said wind-collecting plates includes a first guiding segment fixedly disposed adjacent to and tapered toward said upright shaft of said blade unit, a second guiding segment disposed adjacent to and pivotable with respect to said first guiding segment, and a driving shaft extending in an axial direction parallel to the pivot axis, mounting said second guiding segment pivotally to said base, and being rotated by said driver so as to move said second guiding segment between the first and second positions.

7. The apparatus as claimed in claim 6, wherein said wind-collecting unit further includes a plurality of reinforcing members each interconnecting said first guiding segments of adjacent two of said wind-collecting plates.

8. The apparatus as claimed in claim 7, further comprising a top wall disposed over said upright shaft and said driving shafts and covering said blade unit and said wind-collecting unit, said upright shaft and said driving shafts being rotatably mounted between said top wall and said base.

9. The apparatus as claimed in claim 8, wherein said blade unit includes a plurality of said blade members arranged axially along said upright shaft, said blades of each of said blade members being misaligned respectively from those of an adjacent one of said blade members along the pivot axis.

10. The apparatus as claimed in claim 6, wherein said first guiding segments of adjacent two of said wind-collecting plates define said wind outlet therebetween, and said second guiding segments of adjacent two of said wind-collecting plates define said wind inlet therebetween.
